(19) United States
(12) Patent Application Publication
(10) Pub. No.: US 2017/0052790 A1
(43) Pub. Date: Feb. 23, 2017

(54) ELECTRONIC DEVICE AND SHUTDOWN METHOD THEREOF

(71) Applicants: Fu Tai Hua Industry (Shenzhen) Co., Ltd., Shenzhen (CN); HON HAI PRECISION INDUSTRY CO., LTD., New Taipei (TW)

(72) Inventor: YIN-ZHAN WANG, Shenzhen (CN)

(73) Assignees: Fu Tai Hua Industry (Shenzhen) Co., Ltd., Shenzhen (CN); HON HAI PRECISION INDUSTRY CO., LTD., New Taipei (TW); HON HAI PRECISION INDUSTRY CO., LTD., New Taipei (TW)

(21) Appl. No.: 15/153,747

(22) Filed: May 13, 2016

(30) Foreign Application Priority Data
Aug. 18, 2015 (CN) 201510508845.6

(51) Int. Cl. G06F 9/44; G06F 1/28; G06F 1/26

(52) U.S. Cl. CPC G06F 9/442; G06F 1/26; G06F 1/28

(57) ABSTRACT

An electronic device having a power supply unit, a power control unit, a physical button, and a storage device is disclosed. The power supply unit detects actuation of the physical button coupled to an information pin of the power supply unit. Then, the power control unit determines whether the actuation of the physical button matches a predefined condition. The power control unit stops the power supply unit from supplying power to the power control unit when the actuation matches the predefined condition.

### CROSS-REFERENCE TO RELATED APPLICATIONS

This application claims priority to Chinese Patent Application No. 201510508845.6 filed on Aug. 18, 2015, the contents of which are incorporated by reference herein.

### FIELD

The subject matter herein generally relates to shutdown of an electronic device.

### BACKGROUND

When an operating system of an electronic device crashes, the electronic device may not respond to a hard boot.

### BRIEF DESCRIPTION OF THE DRAWINGS

Implementations of the present technology will now be described, by way of example only, with reference to the attached figures.

FIG. 1 is a block diagram of one embodiment of an electronic device.

FIG. 2 is a diagrammatic view of one embodiment of a circuit in the electronic device of FIG. 1.

FIG. 3 is a block diagram of one embodiment of function modules of a shutdown system in the electronic device of FIG. 1.

FIG. 4 illustrates a flowchart of one embodiment of a shutdown method for the electronic device of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

The term “comprising” means “including, but not necessarily limited to”; it specifically indicates open-ended inclusion or membership in a so-described combination, group, series, and the like.

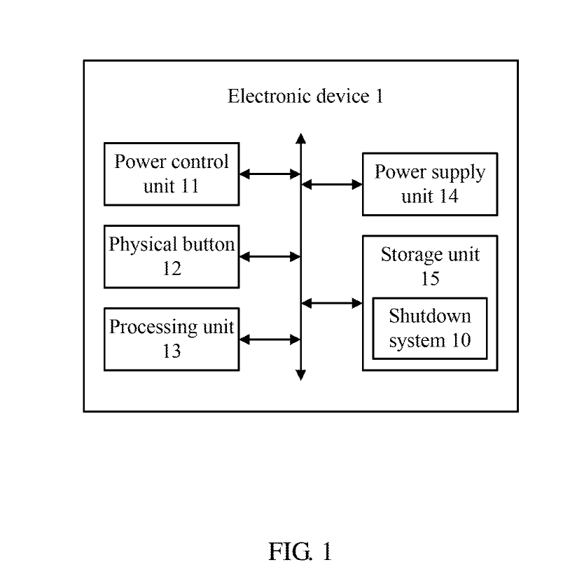

FIG. 1 illustrates an embodiment of an electronic device 1. In the embodiment, the electronic device 1 can include a power control unit 11, at least one physical button 12, a processing unit 13, a power supply unit 14, and a storage unit 15. In at least one embodiment, the power control unit 11, the at least one physical button 12, the processing unit 13, the power supply unit 14, and the storage unit 15 are coupled to and communicating with each other via a system bus. In at least one embodiment, the electronic device 1 can be a mobile phone, a tablet, a personal digital assistant (PDA), or other portable device. In at least one embodiment, a shutdown system 10 stored in the storage unit 15 having a plurality of instructions can be operated in the electronic device 1. FIG. 1 illustrates only one example of an electronic device 1, the electronic device in other embodiments can include more or fewer components than illustrated, or have a different configuration of the various components.

In at least one embodiment, the power control unit 11 can be a low-dropout (LDO) regulator, a direct current to direct current (DC/DC) converter, or other electronic component including a power control chip. The power control unit 11 receives power from the power supply unit 14, manages the power of the power supply unit 14 and distributes the power to each component of the electronic device 1. In at least one embodiment, the power control unit 11 can include a VOL_UP_KEY pin, a VOL_DN_KEY pin, a POWER_KEY pin, and a MENU_KEY pin, and other pins.

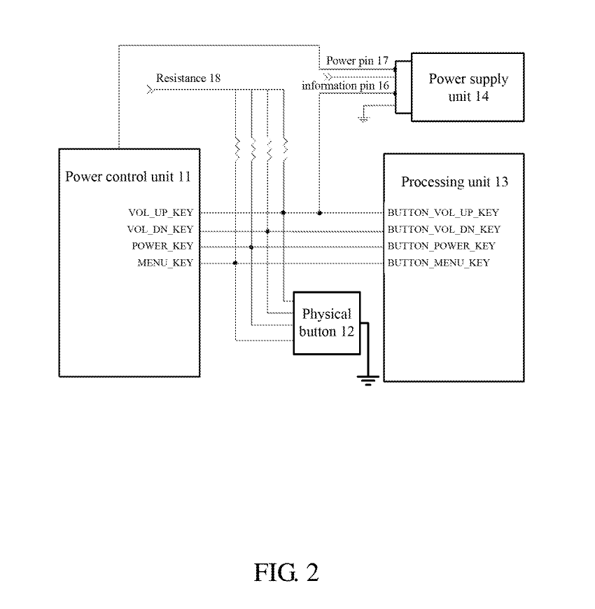

In at least one embodiment, the at least one physical button 12 is the buttons installed on the electronic device 1. In at least one embodiment, the at least one physical button 12 can be a VOL_UP button, a VOL_DN button, a POWER button, a MENU button, and other buttons. In at least one embodiment, when the at least one physical button 12 is not actuated, each voltage level of the at least one physical button 12 can remain at a high voltage level. When one of the physical buttons 12 is actuated, the voltage level of the actuated physical button can be shifted from high to low voltage level. For example, as shown in FIG. 2, each of the at least one physical button 12 is coupled to a pull-up resistor 18. When the VOL_UP button coupled to the pull-up resistor 18 is actuated, the voltage level of the VOL_UP button can be shifted from high to low voltage level.

In at least one embodiment, the processing unit 13 can be a processor, a central processing unit (CPU), a graphic processing unit (GPU), a digital signal processor (DSP), a system on chip (SoC), a field-programmable gate array (FPGA), or a controller for executing the program instruction in the storage unit 15 which can be static RAM (SRAM), dynamic RAM (DRAM), EPROM, EEPROM, flash memory, or other types of computer memory. The processing unit 13 can further include an embedded system or an application specific integrated circuit (ASIC) having embedded program instructions. In at least one embodiment, the instructions stored in the storage unit 15 can be executed by the processing unit 13 to perform functions of the electronic device 1. In at least one embodiment, the processing unit 13 can include a BUTTON_VOL_UP_KEY pin, a BUTTON_VOL_DN_KEY pin, a BUTTON_POWER_KEY pin, and a BUTTON_MENU_KEY pin, and other pins.

In at least one embodiment, the power supply unit 14 can be a battery to supply power to the electronic device 1, such as a rechargeable battery including a lithium ion battery. In at least one embodiment, the power supply unit 14 can include a plurality of pins coupled to other components of the electronic device 1. For example, as shown in FIG. 2, the power supply unit 14 can include an information pin 16 coupled to one of the physical buttons 12, a power pin 17 (BATT_VCC pin) coupled to the power control unit 11, and a ground pin. In at least one embodiment, the power supply unit 14 can include a plurality of information pins 16.

In at least one embodiment, the storage unit 15 can be a non-volatile computer readable storage medium that can be electrically erased and reprogrammed, such as read-only memory (ROM), random-access memory (RAM), erasable programmable ROM (EPROM), electrically erasable programmable ROM (EEPROM), hard disk, solid state drive, or other forms of electronic, electromagnetic, or optical recording medium. In at least one embodiment, the storage unit 15 can include interfaces that can access the aforementioned computer readable storage medium to enable the electronic device 1 to connect and access such computer readable storage medium. In at least one embodiment, the storage unit 15 can be a smart media card, a secure digital card, or a flash card. In at least one embodiment, the storage unit 15 can store at least one of the instructions of the shutdown system 10, function instructions of the electronic device 1, and the data of the electronic device 1.

FIG. 2 illustrates an embodiment of a circuit in the electronic device 1 of FIG. 1. In at least one embodiment, the power control unit 11 is coupled to the processing unit 13. In at least one embodiment, the VOL_UP_KEY pin of the power control unit 11 is coupled to the BUTTON_VOL_UP_KEY pin of the processing unit 13, the VOL_DN_KEY pin of the power control unit 11 is coupled to the BUTTON_VOL_DN KEY pin of the processing unit 13, the POWER_KEY pin of the power control unit 11 is coupled to the BUTTON_POWER_KEY pin of the processing unit 13, and the MENU_KEY pin of the power control unit 11 is coupled to the BUTTON_MENU_KEY pin of the processing unit 13. In at least one embodiment, the power control unit 11 is coupled to the power pin 17 of the power supply unit 14 to receive the power from the power supply unit 14.

In at least one embodiment, the at least one physical button 12 is coupled to the power control unit 11 and the processing unit 13 to provide a voltage level change of the at least one physical button 12 to the power control unit 11 and the processing unit 13. For example, the at least one physical button 12 can include a volume up button, a volume down button, a power button, and a menu button. The volume up button is coupled to the VOL_UP_KEY pin of the power control unit 11 and the BUTTON_VOL_UP_KEY pin of the processing unit 13 to provide a voltage level change of the volume up button. The volume down button is coupled to the VOL_DN_KEY pin of the power control unit 11 and the BUTTON_VOL_DN_KEY pin of the processing unit 13 to provide a voltage level change of the volume down button. The power button is coupled to the POWER_KEY pin of the power control unit 11 and the BUTTON_POWER_KEY pin of the processing unit 13 to provide a voltage level change of the power button. The menu button is coupled to the MENU_KEY pin of the power control unit 11 and the BUTTON_MENU_KEY pin of the processing unit 13 to provide a voltage level change of the menu button. In at least one embodiment, each physical button 12 can be coupled to the power control unit 11. In other embodiments, each physical button 12 can be separated from the power control unit 11.

In at least one embodiment, the processing unit 13 is coupled to each of the at least one physical button 12 to receive each voltage level change from the at least one physical button 12. The power pin 17 of the power supply unit 14 is coupled to the power control unit 11 to supply power to the power control unit 11. When the power supply unit 14 only has an information pin 16, the information pin 16 of the power supply unit 14 is coupled to a specific one of the physical button 12 to detect the voltage level change of the specific physical button. The specific physical button can be the volume up button, the volume down button, the power button, the menu button, or other buttons. For example, as shown in FIG. 2, the information pin 16 of the power supply unit 14 is coupled to the volume up button of the electronic device 1 to detect the voltage level change of the volume up button. When the information pin 16 is coupled to the specific physical button and the other buttons, the voltage level change of the specific physical button can be influenced by the voltage level changes of the other buttons. Therefore, the information pin 16 can be only coupled to the specific physical button to prevent the voltage level change of the specific physical button from the influence of the other buttons and to precisely detect the voltage level change of the specific physical button.

In at least one embodiment, the specific physical button is in one-to-one correspondence with the information pin 16. Therefore, when the power supply unit 14 only has an information pin 16, the information pin 16 is coupled only to the specific physical button. A voltage level change detected by the information pin 16 is the voltage level change of the specific physical button. In at least one embodiment, the number of the specific physical buttons coupled to the information pins is determined by the number of the information pins 16 in the power supply unit 14. Therefore, when the power supply unit 14 includes a plurality of information pins 16, the plurality of information pins 16 can be coupled in one-to-one correspondence with a plurality of physical buttons 12 to individually detect voltage level changes of the physical buttons 12. For example, a first information pin can detect a voltage level change of the volume up button, and a second information pin can detect a voltage level change of the power button.

In at least one embodiment, when the specific physical button is coupled to the information pin 16 and the power control unit 11 simultaneously, the power control unit 11 can assist the information pin 16 in detecting the voltage level change of the specific physical button. For example, when the power control unit 11 receives the voltage level change of the specific physical button, the power control unit 11 can provide the voltage level change to the information pin 16. The information pin 16 can compare the detected voltage level change with the voltage level change received from the power control unit 11 to determine whether the detected voltage level change is the voltage level change of the specific physical button.

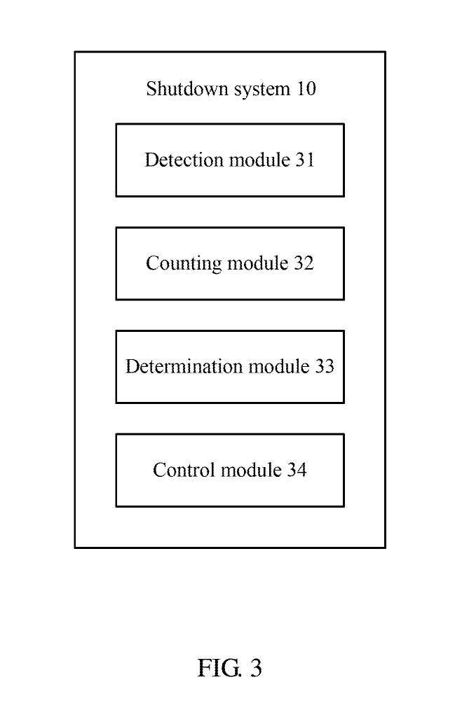

FIG. 3 illustrates an embodiment of function modules of the shutdown system 10 in the electronic device 1 of FIG. 1. In at least one embodiment, the shutdown system 10 can include one or more modules, for example, a detection module 31, a counting module 32, a determination module 33, and a control module 34. “Module,” as used herein, refers to logic embodied in hardware or firmware, or to a collection of software instructions, written in a programming language, such as, JAVA, C, or assembly. One or more software instructions in the modules can be embedded in firmware, such as in an EPROM. The modules described herein can be implemented as either software and/or hardware modules and can be stored in any type of non-transitory computer-readable medium or other storage unit. Some non-limiting examples of non-transitory computer-readable media include CDs, DVDs, BLU-RAY, flash memory, and hard disk drives. In at least one embodiment, the modules described herein can be implemented by the power control unit 11 and power supply unit 14.

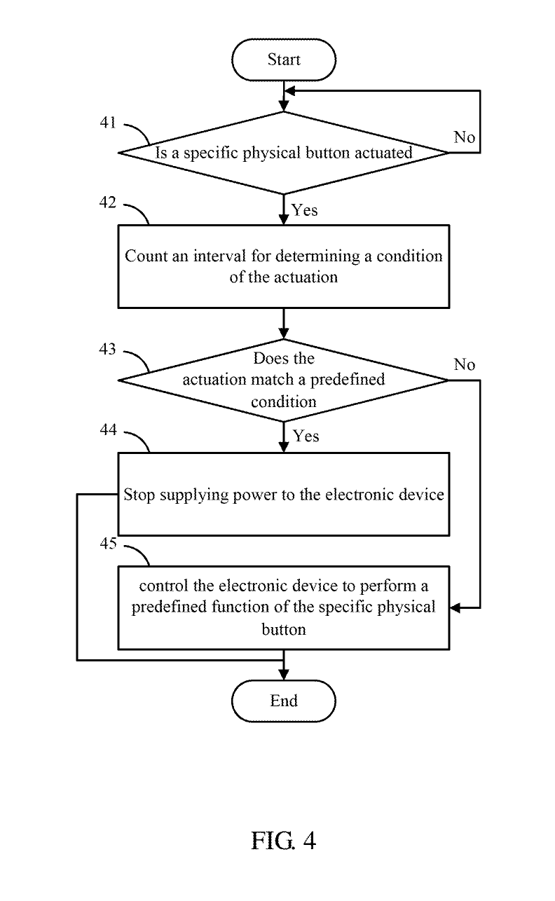

FIG. 4 illustrates a flowchart of a method in accordance with an example embodiment. The example method is provided by way of example, as there are a variety of ways to carry out the method. The method described below can be carried out using the configuration illustrated in FIG. 1, for example, and various elements of these figures are referenced in explaining example method. Each block shown in FIG. 4 represents one or more processes, methods, or subroutines, carried out in the example method. Furthermore, the order of blocks is illustrative only and can change. Additional blocks can be added or fewer blocks can be utilized, without departing from this disclosure. The example method can begin at block 41.

At block 41, the detection module 31 detects actuation of the specific physical button and determines whether the specific physical button is actuated or not. If the specific physical button is not actuated, the procedure goes back to block 41. If the specific physical button is actuated, the procedure goes to block 42.

In at least one embodiment, the electronic device 1 includes a power supply unit 14 and at least one physical button 12. The power supply unit 14 includes an information pin 16, and the information pin 16 is coupled to the specific physical button 12. In at least one embodiment, the detection module 31 controls the information pin 16 of the power supply unit 14 or the power control unit 11 to detect whether the specific physical button is actuated. In at least one embodiment, actuation of the physical button can be, but not limited to press, touch, click, push, and pull of the physical button.

In at least one embodiment, the specific physical button is coupled to a pull-up resistor 18. When the specific physical button is not actuated, the voltage level of the specific physical button can remain at a high voltage level. When the specific physical button is actuated, the voltage level of the specific physical button can be shifted from high to low voltage level. Therefore, when the detection module 31 detects that the voltage level of the specific physical button is shifted from high to low voltage level, the detection module 31 determines that the specific physical button is actuated.

At block 42, the counting module 32 counts an interval for determining a condition of the actuation for the specific physical button. In at least one embodiment, the counting module 32 counts the interval when the specific physical button is actuated. In at least one embodiment, the counting module 32 counts a time interval during the low voltage level of the specific physical button and sets the time interval as the interval.

At block 43, the determination module 33 determines whether the actuation of the specific physical button matches a predefined condition. If the actuation matches the predefined condition, the procedure goes to block 44. If the actuation does not match the predefined condition, the procedure goes to block 45.

In at least one embodiment, the condition of the actuation can be represented as the interval, and the predefined condition can be defined as a long actuation condition that the interval is longer than a predefined threshold. In at least one embodiment, the predefined threshold can be three seconds or other intervals. Thus, the determination module 33 determines whether the condition of the actuation matches the long actuation condition according to the predefined threshold to determine whether the actuation matches the predefined condition.

In at least one embodiment, when the determination module 33 determines that the interval is not longer than the predefined threshold, the determination module 33 determines that the actuation does not match the predefined condition. When the determination module 33 determines that the interval is longer than the predefined threshold, the determination module 33 determines that the actuation matches the predefined condition.

In at least one embodiment, when an operating system of the electronic device 1 and the processing unit 13 is working, a predefined function of the specific physical button can be performed. Thus, the determination module 33 determines that the actuation does not match an initiation condition of the predefined condition and the procedure goes to block 45. In at least one embodiment, when the operating system of the electronic device 1 executed by the processing unit 13 crashes, the determination module 33 determines that the actuation of the specific physical button matches the initiation condition of the predefined condition.

At block 44, the control module 34 stops from supplying power to the electronic device 1. In at least one embodiment, the control module 34 can separate the power pin 17 of the power supply unit 14 from the power control unit 11 to stop the power supply. In at least one embodiment, when the processing unit 13 of the electronic device 1 is operating normally, the control module 34 can keep the power pin 17 of the power supply unit 14 coupled to the power control unit 11 if the actuation matches the predefined condition.

At block 45, the control module 34 can keep supplying power to the electronic device and the processing unit 13 can control the electronic device 1 to perform the predefined function of the specific physical button. In at least one embodiment, when the operating system of the electronic device 1 is working, the predefined function can be performed if the operation of the predefined function is not influenced by the operating system of the electronic device 1.

In at least one embodiment, the information pin 16 of the power supply unit 14 coupled to the specific physical button detects the voltage level change of the specific physical button. When the condition of the voltage level change matches the predefined condition, the power supply unit 14 can stop supplying power to the electronic device 1. When the operating system of the electronic device 1 crashes, the processing unit cannot operate normally. Therefore, the user can shutdown the power supply by actuating the specific physical button, when the electronic device 1 cannot be turned off normally.

In at least one embodiment, the number of the information pins 16 in the power supply unit 14 can be more than one. For example, when the number of the information pins 16 in the power supply unit 14 is two, the first information pin of the power supply unit 14 can be coupled to a first specific physical button, and the second information pin of the power supply unit 14 can be coupled to a second specific physical button. When the first and second specific physical buttons are actuated simultaneously and both of the actuations of the two specific physical buttons match the predefined condition, the power supply unit can stop supplying power to the power control unit 11 of the electronic device 1.

The embodiments shown and described above are only examples. Even though numerous characteristics and advantages of the present technology have been set forth in the foregoing description, together with details of the structure and function of the present disclosure, the disclosure is illustrative only, and changes can be made in the detail, including in matters of shape, size, and arrangement of the parts within the principles of the present disclosure, up to and including the full extent established by the broad general meaning of the terms used in the claims.

What is claimed is:

1. An electronic device, comprising:
a power supply unit having an information pin;
a power control unit coupled to the power supply unit;
a physical button coupled to the information pin; and
a storage unit that stores a plurality of instructions, that causes the power control unit to:
detect actuation of the physical button;
determine whether the actuation of the physical button matches a predefined condition; and
stop the power supply unit from supplying power to the power control unit when the actuation matches the predefined condition.

2. The electronic device according to claim 1, further comprising instructions to:
count an interval when the physical button is actuated.

3. The electronic device according to claim 2, wherein the actuation matches the predefined condition when the interval is longer than a predefined interval.

4. The electronic device according to claim 1, further comprising instructions to:
detect whether a voltage of the physical button is changed; and
determine the physical button is actuated when the voltage of the physical button is changed.

5. The electronic device according to claim 1, further comprising instructions to:
detect whether a voltage of the information pin is changed; and
determine the physical button is actuated when the voltage of the information pin is changed.

6. The electronic device according to claim 1, comprising:
a processing unit coupled to the information pin of the power supply unit and the power control unit.

7. The electronic device according to claim 6, wherein the power control unit stops the power supply unit from supplying power to the power control unit when an operating system executed by the processing unit crashes and the power control unit detects that the actuation matches the predefined condition.

8. A method for shutting down an electronic device having at least one physical button, a power control unit and a power supply unit including an information pin coupled to a physical button, the method comprising:
detecting actuation of the physical button via the information pin;
determining whether the actuation of the physical button matches a predefined condition; and
stopping the power supply unit from supplying power to the power control unit when the actuation of the physical button matches the predefined condition.

9. The method according to claim 8, further comprising:
counting an interval when the physical button is actuated.

10. The method according to claim 9, wherein the actuation matches the predefined condition when the interval is longer than a predefined interval.

11. The method according to claim 8, further comprising:
detecting whether a voltage of the physical button is changed; and
determining the physical button is actuated when the voltage of the physical button is changed.

12. The method according to claim 8, further comprising:
detecting whether a voltage of the information pin is changed; and
determining the physical button is actuated when the voltage of the information pin is changed.

13. The method according to claim 8, wherein the electronic device includes a processing unit coupled to the power control unit and the information pin of the power supply unit.

14. The method according to claim 13, wherein the power control unit stops the power supply unit from supplying power to the power control unit when an operating system executed by the processing unit crashes and the power control unit detects that the actuation matches the predefined condition.
